(19) United States
(12) Patent Application Publication
(10) Pub. No.: US 2006/0102015 A1
(43) Pub. Date: May 18, 2006

(54) Retractable oven rack assembly

(75) Inventors: Edward Baker, Waverly, TN (US); George May, New Bern, NC (US); Howard Saunders, Goodlettsville, TN (US); Manfred W. Staebler, New Bern, NC (US); Daron Whitehead, Murfreesboro, TN (US)

Correspondence Address: JOHN T. WINBURN, 100 BOSCH BOULEVARD, NEW BERN, NC, 28562, US

(73) Assignee: BSH Home Appliances Corporation, Huntington Beach, CA (US)

(21) Appl. No.: 10/987,634

(22) Filed: Nov. 12, 2004

(51) Int. Cl. A47J 37/07

(52) U.S. Cl. 99/450

(57) ABSTRACT

A retractable oven rack is made up of two separate parts, a first part being a slidable wire base, which is rectangularly shaped and has four wire sections extending generally horizontally around the periphery thereof. Two of the wire sections extend parallel to each other along the width of the wire base and the other two extend parallel along the length. The four wires sections are connected to each other at the ends thereof. A pair of support rods are located from and extending respectively parallel to two of the wire sections along the length of the slidable wire base. The second part is a grid shelf having a pair of raised wire sections extending the length of the grid shelf located at a position for being slidably supported on the pair of support rods for allowing the grid shelf to be supported and slide on the pair of support rods.

### BACKGROUND OF THE INVENTION

1. Field of the Invention

This invention relates to a retractable oven rack assembly for use in an oven. The invention also relates to a combination oven and retractable oven rack. More particularly, the invention relates to a retractable oven rack assembly made up of two parts, with a grid shelf supported on a slidable base which can be slid out of the oven, and the grid shelf is slidable on top of the base for being easily extended out of and retracted back into the oven cavity.

2. Discussion of the Prior Art

In cooking appliances such as ovens or free standing ranges which include ovens, the oven cavity is typically populated with one or more racks to support food items being cooked in the oven. The oven cavities include support slots, racks or ledges in the side walls thereof which allow the oven racks to be slidably received and retained within the oven cavity. The support slots, racks or ledges also typically include an upward or downward projection near the front of the oven cavity which serves as a stop which abuts against a corresponding projection in one or both of the front and in the back of an oven rack. The stop prevents the oven rack from being inadvertently pulled completely out of the oven when supporting food thereon, and to prevent the oven rack from being pushed too far back into the oven to avoid contact between the rear of the oven rack and the interior back wall of the oven cavity. The oven rack is easily removed from the support slots, racks or ledges for moving to another height in the oven or for removable for cleaning.

In these types of arrangements, due to the fact that the oven rack must be supported over a substantial portion thereof by the support slots or ledges of the oven cavity walls, the amount which the rack can be extended out of the oven cavity is limited. This results in difficulty in positioning food items on such racks or in removing the food items from the rack. This also creates a danger that the person removing or replacing such items on the rack may inadvertently contact the hot walls of the oven cavity.

More recently, in order to avoid these problems, there have been designed extendable rack arrangements for use in an oven cavity, which allow an oven rack to be extended well out of an oven cavity. One design involves a rack assembly, which includes a rack extendable upon a primary rack frame, which is itself mounted for sliding movement relative to the oven cavity. The rack is supported upon guides carried by the rack frame with multiple sets of rollers. While desirable from the perspective of allowing greater extension of the oven rack out of the cavity of the oven, this type of arrangement takes up a substantial amount of additional space within an oven cavity due to the fact that it is essentially a double rack arrangement, with each rack separated from each other by a space consuming roller mechanism which can easily break. As such, while desirable from the perspective of allowing the rack to be extended outside of the oven cavity, this type of rack arrangement substantially decreases the useable volume in an oven cavity, particularly when multiple rack assemblies of this type are used. Further, the complexity of the extendable rack assembly adds cost to the oven and may also cause failures due to the many moving parts of the extendable rack assembly.

In a more recent arrangement, a full extension slide is provided on a rack frame resting on the supports, such as slots, racks or ledges of the oven, with a rack coupled to the full extension slide. In this arrangement, the rack frame rests on supports of the oven with the upper portion of the rack frame holding the extension slides at essentially the same level as the rack coupled to the full extension slide.

While providing a more simplified arrangement than the afore-described double rack assembly, this design still suffers from the requirement of having a compound rack system wherein two racks are required, one being a wire frame rack and the other being the actual rack that holds the food being cooked in the oven.

In accordance with the invention, the problems of the extendable open racks in current use are avoided, and an oven rack assembly is provided which allows full extension of an oven rack outside of an oven cavity, is simple in construction, and ensures that the oven rack is securely held by the supports of the oven cavity.

### BRIEF SUMMARY OF THE INVENTION

In one aspect there is disclosed a retractable oven rack which includes a slidable wire base of generally rectangular shape with four wire sections extending generally horizontally around the periphery thereof. A first two of the wire sections extend parallel to each other along the width of the wire base and a second two extend parallel to each other along the length thereof. By “width” it is meant the portion which extends along the front entrance of the oven cavity. By “length” is the portion that extends inwardly through the depth of the oven cavity. The wire sections are connected to each other at the ends thereof and are preferably a single continuous piece. A pair of support rods are located raised from and extend respectively parallel to the second two wire sections in proximity thereto. The support rods are connected at each end to a respective one of the first two wire sections. A grid shelf has a pair of raised wire sections extending the length of the grid shelf at a location for being slidably supported on the pair of support wire sections, for allowing the grid shelf to slide on the pair of support rods.

In a more specific aspect, one of the first two wire sections includes a raised section at the rear of the wire base to form respective first stops at the connections between the wire section of the first two wire sections at the rear, and the second two wire sections. The other end of the first two wire sections includes a raised section at the front of the of the wire base to form a second set of stops. In a yet still further aspect, the base includes a projection on each of the support wire sections to form a wire grid shelf stop for limiting sliding movement of the grid shelf relative to the wire base to a predetermined amount forward to prevent the grid shelf from inadvertently falling out of the oven when it is extended outward from its retracted position.

In a yet still further aspect, the invention includes the aforementioned retractable oven rack in combination with an oven, which contains at least one of the aforedescribed retractable oven racks therein.

### BRIEF DESCRIPTION OF THE SEVERAL VIEWS OF THE DRAWING

Having briefly described the present invention, the same will become better understood from the following detailed description, made with reference to the appended drawing, wherein:

FIG. 1 is a perspective view showing an oven and the retractable oven racks of the present invention shown received within an oven cavity.

FIG. 2 is a perspective view of the wire base of the retractable oven rack;

FIG. 3 is a perspective view of the grid shelf of the retractable oven rack;

FIG. 4 is a perspective view of the oven rack assembly of the present invention shown with the grid shelf assembled on the wire base;

FIG. 5 is a view as in FIG. 4 but showing the grid shelf slidably extended over and from the wire base;

FIG. 6 is a partial side view showing a stop for limiting movement of the grid shelf when it is extended outwardly from an oven by sliding on the wire base;

FIG. 7 is a view as in FIG. 6 but showing the grid shelf extended and stopped by the stop of the wire base; and

FIG. 8 is a perspective view of the retractable oven rack illustrating how the grid shelf can be disassembled from the wire base by turning them relative to one another.

### DETAILED DESCRIPTION OF THE INVENTION

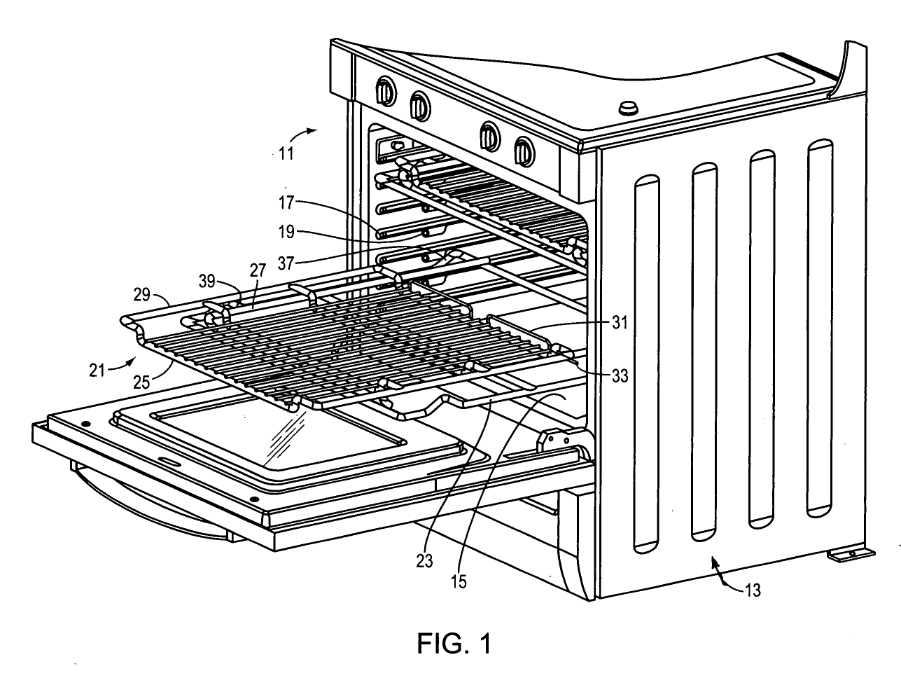

FIG. 1 is a perspective view of the oven rack system 11 in accordance with the present invention. An oven 13 includes an oven cavity 15 and oven rack support, here a plurality of shelves 17, with the respective parallel opposite shelves not shown. The shelves 17 each include a shelf stop 19, which serves to limit the movement of an oven rack outwardly from the cavity 15 and into the oven cavity 15.

A retractable oven rack 21 in accordance with the present invention includes two separate parts, a slidable wire base 23 and a grid shelf 25.

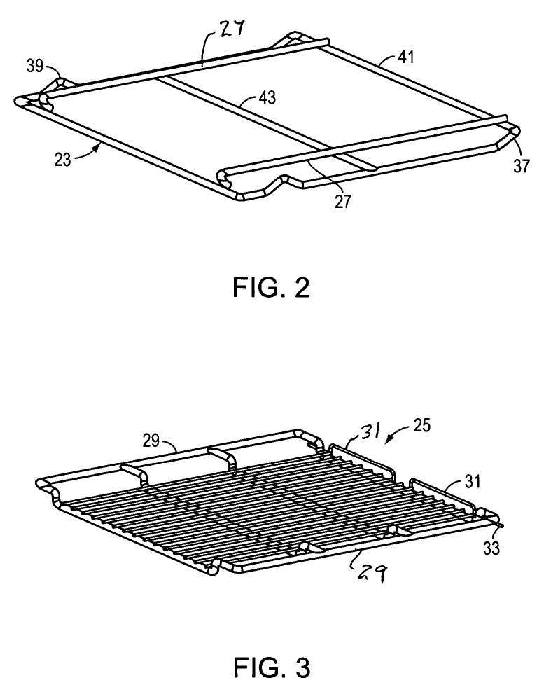

As shown in FIG. 2, the wire base 23 is made of four generally horizontally extending wire sections, two along the width and two along the length thereof. The wire base includes a pair of support rods 27 connected thereto and a strengthening rod 43 extending across the middle of the wire base 23 along the width thereof. A wire rod 41 is positioned at the rear, and makes up one of the two wire sections extending along the length of the wire base 23. The wire rod 41 is preferably raised to create a bent portion 37 at the rear of the wire base which serves as a stop when the wire base 23 is extended out of the oven cavity 15 by abutting against the shelf stop 19. Both of the support rods 27 serve to support the grid shelf 25 in sliding relationship thereto.

As shown in FIG. 3, the grid shelf 25 includes a pair of raised wire sections 29 which rest on the raised supports 27 in sliding relationship thereto. The rear of the grid shelf 25 also includes a pair of wire elements 31 attached to create a wall at the rear of the grid shelf 25 to prevent articles from “sliding off” the rear of the grid shelf 25.

As also shown in FIGS. 1 and 3, the grid shelf 25 includes a grid stop member 33 as an extension of the rear of the grid shelf 25 which extends below the raised support rods 27 to abut against a wire base grid shelf stop (discussed hereafter) to limit movement of the grid shelf 25 when extended out from the oven cavity 15.

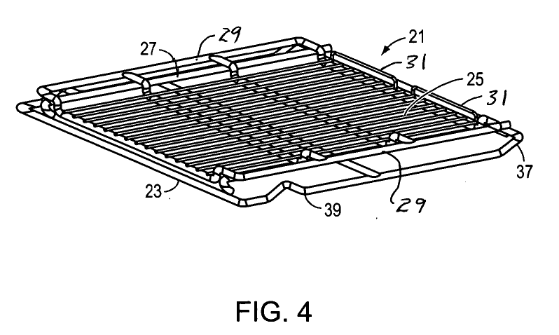

FIG. 4 illustrates the retractable oven rack 21 in assembled form with the wire base 23 having the grid shelf 25 supported thereon. The bent portion stop 37, which abuts against shelf stop 19 is more clearly shown in this view. In addition, the wire base 23 also includes a bent portion 39 near the front thereof which serves as a second stop when the retractable oven rack 21 is fully received within the oven cavity, to abut against the shelf stop 19 to prevent further movement of the retractable oven rack into the oven cavity 15 and thus, prevent it from hitting the back wall of the oven cavity 15.

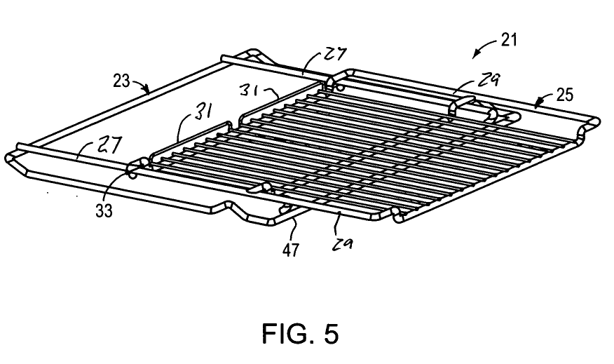

FIG. 5 shows an alternative embodiment of the retractable oven rack of the invention in which the front of the wire base 23 has a portion 47 at the front thereof which is bent downward to provide spacing to allow a user to directly hold on to the wire base 23 without contact with the grid shelf 25. FIG. 5 also more clearly illustrates the grid shelf stop member 33 with the grid shelf 25 in extended condition relative to the wire base 23.

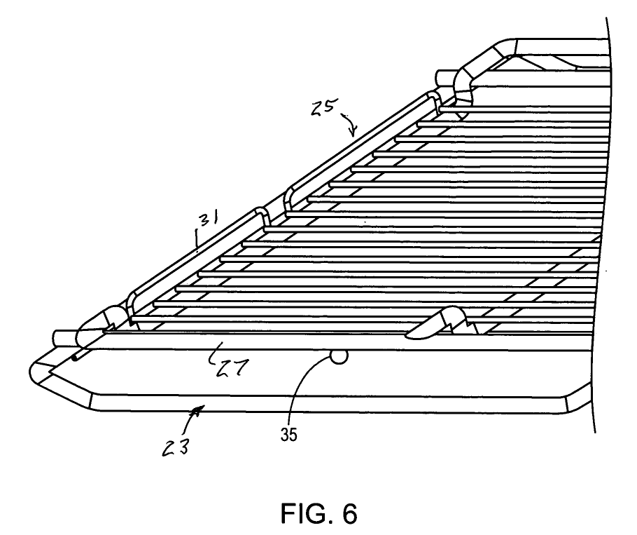

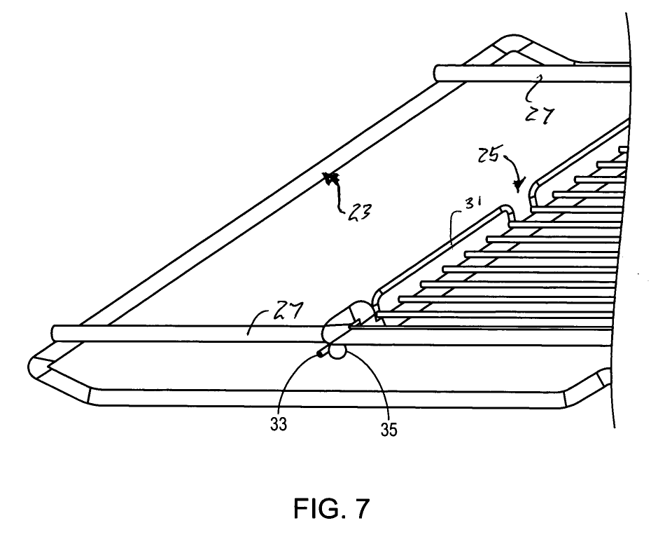

FIGS. 6 and 7 further illustrate the relationship between the grid shelf stop 33 and a wire base grid shelf stop 35. In this case, the wire based grid shelf stop 35 is made up of a bead attached to the support rods 27 on the underside thereof. FIG. 7, in particular illustrates the grid shelf 35 in a partial view in fully extended condition with the grid shelf stop 33 in abutment with the wire base grid shelf stop 37.

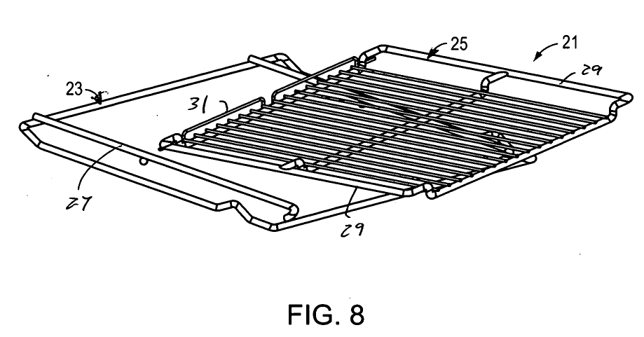

FIG. 8 illustrates how the separate wire base 23 and the grid shelf 25 of the retractable oven rack 21 can be disassembled. This is done by a twisting operation whereby the grid shelf stop 33 becomes disengaged from beneath the raised support 27 at one end thereof to allow disassembly of the retractable oven rack 21, for example, for cleaning purposes.

With respect to the materials employed, a variety of conventional metals or alloys can be used in manufacturing the retractable oven rack 21. Examples of such materials are nickel-plated carbon steel wire or nickel chrome cold rolled rod. More particularly, the materials should be capable of withstanding typical oven temperatures over long periods of time as will become readily apparent to those of ordinary skill in the art.

Having thus generally described the invention, the same will become better understood from the appended claims in which it is set forth in a non-limiting manner.

What is claimed is:

1. A retractable oven rack, comprising:
a slidable wire base of generally rectangular shape having four wire sections extending generally horizontally around the periphery thereof, a first two wire sections extending parallel to each other along the width of the wire base, and a second two wire sections extending parallel to each other along the length of the wire base, and the wire sections connected to each other at ends thereof;
a pair of support rods located raised from and extending respectively parallel to the second wire sections in proximity thereto, and connected at each end to a respective one of the first two wire sections; and
a grid shelf having a pair of raised wire sections extending the length of the grid shelf at a location for being slidably supported on said pair of support rods for allowing the grid shelf be supported on and to slide on the pair of support wire sections.

2. The retractable oven rack of claim 1, wherein the second two wire sections further include a section at the rear of the wire base shaped to form respective first stops at the rear of the second two wire sections.

3. The retractable oven rack of claim 1, further including a bend in each of the second two wire sections at a location in proximity to the front of the wire base to form respective second stops.

4. The retractable oven rack of claim 1, further including a projection on each support rod, each forming a wire base grid shelf stop for limiting the sliding movement of the grid shelf relative to the wire base to a predetermined amount as a result of engagement between the grid shelf and each stop.

5. The retractable oven rack of claim 3, further including a projection on each support rod, each forming a wire base grid shelf stop for limiting the sliding movement of the grid shelf relative to the wire base to a predetermined amount as a result of engagement between the grid shelf and each stop.

6. The retractable oven rack of claim 1, wherein the wire section of the first two wire sections located at the rear of the slidable wire base is raised relative to the other one of said first two wire sections.

7. The retractable oven rack of claim 2, wherein the wire section of the first two wire sections located at the rear of the slidable wire base is raised relative to the other one of said first two wire sections.

8. The retractable oven rack of claim 1, wherein said first two wire sections and said second two wire sections are formed as a continuous wire base.

9. The retractable oven rack of claim 1, wherein said slidable wire base, support wire sections and grid shelf are made of stainless steel capable of withstanding oven temperatures.

10. The retractable oven rack of claim 4, wherein said slidable wire base, support wire sections and grid shelf are made of stainless steel capable of withstanding oven temperatures.

11. A rack system, comprising:
an oven having at least one pair of shelf members on opposite inner side walls thereof for receiving supported thereon an oven rack assembly;
a stop associated with each one of said at least one pair of shelf members for engaging stops on an oven rack assembly for preventing the said oven rack assembly from being pushed too far into the oven and from being pulled too far out of the oven when supported on said at least one pair of shelf members, and moved into and partially out of the oven in sliding engagement therewith; and
at least one retractable oven rack comprising;
a slidable wire base of generally rectangular shape having four wire sections extending generally horizontally around the periphery of the wire base, a first two wire sections extending parallel to each other along the width of the base, and a second two wire sections extending parallel to each other along the length of the wire base, and the wire sections connected to each other at the ends thereof;
a pair of support rods located raised from and extending respectively parallel to the second wire sections in proximity thereto, and connected at each end to a respective one of the first two wire sections; and
a grid shelf having a pair of raised wire sections extending the length of the grid shelf at a location slidably supported on said pair of support rods for allowing said grid shelf to be supported on and slide on the pair of support wire sections.

12. The oven rack system of claim 11, wherein the second two wire sections further include a section at the rear of the wire base shaped to form respective first stops at the rear of the second two wire sections.

13. The oven rack system of claim 11, further including a bend in each of the second two wire sections at a location in proximity to the front of the wire base to form respective second stops.

14. The oven rack system of claim 11, further including a projection on each support rod, each forming a wire base grid shelf stop for limiting the sliding movement of the grid shelf relative to the wire base to a predetermined amount as a result of engagement between the grid shelf and each stop.

15. The oven rack system of claim 13, further including a projection on each support rod, each forming a wire base grid shelf stop for limiting the sliding movement of the grid shelf relative to the wire base to a predetermined amount as a result of engagement between the grid shelf and each stop.

16. The oven rack system of claim 11, wherein the wire section of the first two wire sections located at the rear of the slidable wire base is raised relative to the other one of said first two wire sections.

17. The oven rack system of claim 12, wherein the wire section of the first two wire sections located at the rear of the slidable wire base is raised relative to the other one of said first two wire sections.

18. The oven rack system of claim 11, wherein said first two wire sections and said second two wire sections are formed as a continuous wire base.

19. The oven rack system of claim 11, wherein said slidable wire base, support wire sections and grid shelf are made of stainless steel capable of withstanding oven temperatures.

20. The oven rack system of claim 14, wherein said slidable wire base, support wire sections and grid shelf are made of stainless steel capable of withstanding oven temperatures.
